(19) United States
(12) Patent Application Publication
(10) Pub. No.: US 2014/0280510 A1
(43) Pub. Date: Sep. 18, 2014

(54) Systems and Methods for Facilitating Delivery of an Item

(71) Applicant: Express Link, LLC d/b/a Laundry 101, Lexington, KY (US)

(72) Inventors: Joseph E Putnam, Lexington, KY (US); James N. Turek, II, Lexington, KY (US); Anthony F. Bonner, JR., Lexington, KY (US)

(73) Assignee: Express Link, LLC d/b/a Laundry 101, Lexington, KY (US)

(21) Appl. No.: 14/201,971

(22) Filed: Mar. 10, 2014

Related U.S. Application Data
(60) Provisional application No. 61/778,495, filed on Mar. 13, 2013.

(51) Int. Cl. H04L 29/08

(52) U.S. Cl. CPC H04L 67/10
USPC 709/203

(57) ABSTRACT

Included are embodiments for facilitating delivery of an item. Accordingly, some embodiments of a method include sending notification to a plurality of clients, the notification indicating a scheduled pickup of items, receiving a response from at least one of the clients indicating confirmation of the desired service, and providing an interface to a delivery personnel indicating the at least one clients that confirmed the desired service. Some embodiments include providing a first route to reach the at least one client and deliver picked up items to an intermediate destination.

### CROSS REFERENCE

This application claims the benefit of U.S. Provisional Application No. 61/778,495, filed Mar. 13, 2013, which is hereby incorporated by reference in its entirety.

### BACKGROUND

1. Technical Description

This application is directed to systems and methods for facilitating delivery of an item and, specifically to embodiments for organizing pickup and/or delivery of items.

2. Related Technology

The treatment and delivery of items, such as the laundry and dry cleaning of garments is a common occurrence. Specifically, many people, offices, and businesses require items to be laundered, dry cleaned, repaired, altered, or otherwise treated. As such, these entities often manually drive their items to the treatment facilities that provide the desired treatment service. While the entities may be able to adequately treat their items, inconvenience becomes an issue because oftentimes these entities do not have the time or ability to manually deliver and pickup the items before and after treatment.

### SUMMARY

Included are embodiments for facilitating delivery of an item. Accordingly, some embodiments of a method include sending notification to a plurality of clients, the notification indicating a scheduled pickup of items, receiving a response from at least one of the clients indicating confirmation of the desired service, and providing an interface to a delivery personnel indicating the at least one clients that confirmed the desired service. Some embodiments include providing a first route to reach the at least one client and deliver picked up items to an intermediate destination.

Also included are embodiments of a system. Some embodiments include a memory component that stores logic that, when executed by a processor, causes the system to send notification to a plurality of clients, the notification indicating a scheduled pickup of items, provide an interface to a delivery personnel indicating the at least one clients that confirmed the desired service and provide a first route to reach the at least one client and deliver picked up items to an intermediate destination.

Still some embodiments include a computing device for facilitating delivery of an item. Embodiments of the computing device include a processor a memory component that is coupled to the processor. The memory component may store logic that, when executed by the processor, causes the computing device to send notification to a plurality of clients, the notification indicating a scheduled pickup of items, provide an interface to a delivery personnel indicating the at least one clients that confirmed the desired service, and provide a first route to reach the at least one client and deliver picked up items to an intermediate destination.

### BRIEF DESCRIPTION

FIG. 1 depicts a computing environment for facilitating delivery of an item, according to embodiments described herein;

FIG. 2 depicts a client interface for an individual to enroll for a service for facilitating delivery of an item, according to embodiments described herein;

FIG. 3 depicts a client interface for providing client with information related to a newly created individual account, according to embodiments described herein;

FIG. 4 depicts a client interface for providing a professional client with information related to a newly created professional account, according to embodiments described herein;

FIG. 5 depicts a client interface for providing a commercial client with information related to a newly created commercial account, according to embodiments described herein;

FIG. 6 depicts a manager interface for viewing new client enrollment, according to embodiments described herein;

FIG. 7 depicts a client interface of a client application, which may include an application or other software for providing treatment functionality, accordingly to embodiments described herein;

FIG. 8 depicts a client interface for providing a reminder for service, according to embodiments described herein;

FIG. 9 depicts a client interface for providing a plurality of options for a client to provide options related to the treatment of items, according to embodiments described herein;

FIG. 10 depicts a client interface for providing progress of an item that has been picked up, according to embodiments described herein;

FIG. 11 depicts a client interface for providing emergency pickup options, according to embodiments described herein;

FIG. 12 depicts a client interface for providing options for submitting a question and/or complaint, according to embodiments described herein;

FIG. 13 depicts a client interface for providing an automated response to receiving a client question and/or complaint, according to embodiments described herein;

FIG. 14 depicts a client interface for resolving a client question and/or complaint, according to embodiments described herein;

FIG. 15 depicts a client interface for providing details of a resolution of a client question and/or complaint, according to embodiments described herein;

FIG. 16 depicts a manager interface for providing a client question and/or complaint, according to embodiments described herein;

FIG. 17 depicts a manager interface for providing a plurality of options related to treatment of items, according to embodiments described herein;

FIG. 18 depicts a manager interface for viewing delivery personnel information, according to embodiments described herein;

FIG. 19 depicts a manager interface for providing details of a delivery personnel, according to embodiments described herein;

FIG. 20 depicts a manager interface for viewing deliveries that a manager oversees, according to embodiments described herein;

FIG. 21 depicts a delivery personnel interface for providing a plurality of options to a delivery personnel, according to embodiments described herein;

FIG. 22 depicts a delivery personnel interface for providing pickups that a delivery personnel will make over a predetermined time, according to embodiments described herein;

FIG. 23 depicts a delivery personnel interface for drop-offs that a delivery personnel will make over a predetermined time, according to embodiments described herein;

FIG. 24 depicts a delivery personnel interface that provides a route the delivery personnel will take for making the pickups and/or drop-offs, according to embodiments described herein;

FIG. 25 depicts a delivery personnel interface that provides options for verifying that a client has been serviced, according to embodiments described herein;

FIG. 26 depicts an intermediate destination interface that provides expected deliveries to an intermediate destination, according to embodiments described herein;

FIG. 27 depicts a interface that provides options for verifying that deliveries were received by the intermediate destination, according to embodiments described herein;

FIG. 28 depicts an intermediate destination interface that provides an indication that one or more items should have been received, according to embodiments described herein;

FIG. 29 depicts a flowchart for the treatment of items, according to embodiments described herein; and

FIG. 30 depicts a computing device that may be utilized for the treatment of items, according to embodiments described herein.

### DETAILED DESCRIPTION

Embodiments disclosed herein relate to systems and methods for facilitating delivery of an item. Specifically, embodiments disclosed herein relate to systems and methods for coordinating pickup and delivery of items, such as laundry, dry cleaning, shoe repair, commodity delivery, etc. Accordingly, these embodiments facilitate communication of data among a client, a delivery personnel, a manager, and an intermediate destination. The intermediate destination may include a treatment facility, a food store, and/or other location that is different than a client location where items may be picked up and/or delivered. This communication of data enables clients to track items that have been picked up to determine expected workload; delivery personnel to determine the pickups and deliveries; and managers to monitor and track delivery personnel, accounting, and/or other data. This provides an efficient and accurate accounting of pickups and deliveries of items.

Additionally, embodiments disclosed herein may be configured to provide notification to a plurality of clients regarding a scheduled service. Based on responses received from the plurality of clients, embodiments may automatically determine a pick up schedule, as well as a first route to complete the pickup schedule. The delivery personnel may then follow the first route to pick up the items and may deliver the picked up items to the intermediate destination. Based on a return schedule for each of the picked up items, embodiments may determine a second route for the delivery personnel to return the items from the intermediate destination to the clients. Embodiments may confirm progress of pickup, delivery, and/or treatment of the items.

FIG. 1 depicts a computing environment for facilitating delivery of an item, according to embodiments described herein. As illustrated, the computing environment includes a network 100 for facilitating communication among the computing devices depicted in FIG. 1. The network 100 may be configured as a wide area network, such as the internet, a cellular network, a mobile data network, etc. and/or as a local network, such as via wireless fidelity (Wi-Fi), near field communication protocol such as Bluetooth™, etc. Also included in FIG. 1 are a remote computing device 102, a client computing device 108, a manager computing device 114, a delivery personnel computing device 120, and an intermediate destination computing device 130.

The remote computing device 102 may be configured as a server, personal computer, tablet computer, mobile computing device, and/or other type of computing device for providing the functionality described herein. Accordingly, the remote computing device 102 may include a remote memory component 104 that stores message providing logic 106a, enrollment receiving logic 106b, data providing logic 106c, and billing logic 106d. As discussed in more detail below, the remote computing device 102 (and the other computing devices illustrated in FIG. 1 include a processing component, such as a remote processing component that may execute the logic stored in the respective memory component. Accordingly, the message providing logic 106a may cause processing component to provide messaging to the client computing device 108, as well as provide details related to the responses to those messages. The enrollment receiving logic 106b may cause the processing component to facilitate enrolling one or more clients for providing the desired service. The data providing logic 106c may cause the processing component to provide the user interfaces and/or data in those user interfaces. The billing logic 106d may be configured for providing billing, revenue, and/or other financial data, as described in more detail below.

Similarly, the client computing device 108 may be configured as a mobile computing device, personal computer, tablet computer, and/or other computing device with input and/or output devices for providing the data described herein. Accordingly, the client computing device 108 may also include a client processing device and a client memory component 110 that stores client messaging logic 112a, item location logic 112b, and client enroll logic 112c. The client messaging logic 112a may cause the client processing device to receive messaging reminders and/or other messages. The client messaging logic 112a may additionally facilitate communication of client responses to the messages received from the remote computing device 102 and/or from other devices of FIG. 1. The item location logic 112b may communicate with the remote computing device 102 and/or other device for determining a location of a client's items. The client enroll logic 112c may provide client interfaces for enrolling a client and/or other client interfaces described herein.

The manager computing device 114 may be configured as a personal computer, tablet computer, mobile computing device, etc and may include a manager processing device and a manager memory component 116. Specifically, the manager computing device 114 may be provided to a manager and/or owner. Depending on the particular business model, a plurality of different managers may manage delivery personnel and/or other employees at various locations. Accordingly, the managers may each be provided with access to information for operation of the locations that that manager oversees. By contrast, the manager computing device 114 may be configured as an owner computing device. As an owner may have access to data for all branches and/or locations, the owner computing device may be provided with unrestricted access to the information provided to all delivery personnel, managers, treatment facilities, clients, etc.

The manager memory component 116 may store delivery personnel management logic 118a and manager billing logic 118b. The delivery personnel management logic 118a may cause the manager processing device to determine drop-offs and pickups of each delivery personnel that the manager has responsibility. The manager billing logic 118b causes the processing device to determine intermediate destination costs, delivery personnel costs, revenue, and/or other billing data. This billing data may be received from the remote computing device 102, from the intermediate destination computing device 130, from the client computing device 108, and/or from other locations.

The delivery personnel computing device 120 may be configured as a mobile computing device, personal computer, tablet computer, global positioning system, and/or other type of computing device for determining location of the vehicle 124, determining mileage traveled, determining fuel charges, determining status of pickups and deliveries, and/or determining other data described in more detail below.

The intermediate destination computing device 130 may be configured as a personal computer, mobile computing device, tablet computer, point of sale system, and/or other computing device. Additionally, the intermediate destination computing device 130 may include an intermediate destination processing component and an intermediate destination memory component 132, which stores intermediate destination billing logic 134a and client tracking logic 134b. The intermediate destination billing logic 134a may cause the intermediate destination processing component to determine client charges that will be provided to the remote computing device 102 and/or to other devices. The client tracking logic 134b may be configured to receive data related to message responses and/or other data for tracking items received from clients, as described in more detail below.

FIG. 2 depicts a client interface 230 for an individual to enroll for a service for facilitating delivery of an item, according to embodiments described herein. Specifically, the remote computing device 102 may be configured as a web server to provide one or more web pages for the treatment of items. One example includes a website for the pickup and delivery of laundered and dry cleaned items. The website may include pricing, details of service, locations of service, client account access, enrollment for service, and/or other features. Accordingly, FIG. 2 illustrates such a client interface 1030 for enrolling for service.

As illustrated, the client interface 230 may provide personal information fields 232 for a potential client to enter personal information. The personal information may include name, address of service, mobile phone number, and/or other information. Upon entering the personal information, the remote computing device 102 may verify that the potential client is located in an area of service. This determination may be built into the client interface 230 (such as providing dropdown options for areas of service), or a determination may be made after the potential client has entered the personal information. Additionally, the client interface 230 includes billing information, which may include a payment option, such as credit card, check, cash, student account, etc.

The client interface 230 also provides a client type field 236 for determining whether delivery will be made to a residential client, a campus client, a individual business client, and/or a corporate client. Other types of clients include apartment clients, Greek housing clients, retirement home clients, etc. The client type may be utilized to better allocate employee resources due to the differences in each type of client. As an example, residential, single household clients may be more time intensive because each client resides at a different location. Campus clients, apartment clients, Greek housing clients, retirement home clients, and individual business clients may be less time intensive because multiple clients may receive service at the same location. Additionally, corporate clients, such as hotels, physician offices, hospitals, massage therapists, etc. may receive different billing rates, delivery schedules, and/or other custom client perks due to the increased volume that a corporate client may provide.

Also included in the client interface 230 is a service type option 238. The service type option 238 may provide the potential client to enter the type of service that is requested. Examples include, laundry delivery, dry cleaning delivery, clothing repair delivery, shoe repair delivery, product delivery (such as food, drinks, etc.), parcel delivery, etc. The client interface 230 also includes a frequency of service field 240. The frequency of service field 240 may be provided to provide the client with the ability to increase or decrease service, based on the predicted need that the client will have. As an example, the client may desire daily, semi-weekly, weekly, bi-weekly, monthly, bi-monthly, etc.

Once enrolment is complete, the remote computing device 102 may store the received data, verify accuracy, and send the data to the manager computing device 114, the delivery personnel computing device 120, and/or the intermediate destination computing device 130. Confirmation may additionally be sent to the client computing device 108.

FIG. 3 depicts a client interface 330 for providing client with information related to a newly created individual account, according to embodiments described herein. Upon completing the data fields of FIG. 2, the client interface 330 may be provided. Depending on the determined client type different information may be provided to the client. In FIG. 3, it was determined that the client is a residential client, campus client, and/or other similar client. Accordingly, the client interface 330 provides an information section 332 for providing assigned day of service, assigned time of service, a service location, an assigned delivery personnel, an assigned delivery personnel contact, an assigned messaging schedule, and/or other data.

Specifically, upon receiving the service address from FIG. 2, the remote computing device 102, and/or a manager may determine a service schedule. This determination may be based on many factors, but oftentimes may be based on a delivery schedule to ensure efficient delivery routes. Specifically, a location of the service address may be determined and compared with current or upcoming delivery personnel routes. Based on which route would be least affected by including the service address, the assigned service day may be determined. Similarly, based on the service day and thus the route that the client has been assigned, an estimated service time may be provided. Assigned delivery personnel may also be provided, as well as the contact information for those delivery personnel. While in some embodiments, the delivery personnel contact may be provided, some embodiments may simply provide a manager contact to reduce the access that a delivery personnel has to a client.

Also included is the assigned messaging schedule. Based on the determined frequency of service, messaging may be provided the day before a scheduled pickup or delivery. As an example, if the client designated weekly service, the remote computing device 102 may determine that the client will be Monday pickup and a Wednesday drop-off. This means that on Monday, the client should make the items available for pickup on Monday. Thus, the remote computing device 102 may schedule a reminder message for Sunday to remind the client to make the items available for pickup. Similarly, a message may be provided on Tuesday to remind the client that the items will be returned on Wednesday. Depending on the particular embodiment, one or both of these reminders may not be provided.

Similarly, in some embodiments, the messaging may take the form of a short messaging system (SMS) text message, email, phone call, etc. Some embodiments however, may be configured to provide the messaging via a user application, as described in more detail below. As such, the remote computing device 102 may be configured to determine the preferred communication mechanism for the reminder messages. This may be determined during enrollment in FIG. 2 and/or via other mechanisms.

Also included in the client interface 330 is a download client application option 334. Upon selecting the download client application option 334, a client application may be downloaded to a desired client device 106. A close option 336 is also provided.

FIG. 4 depicts a client interface 430 for providing a professional client with information related to a newly created professional account, according to embodiments described herein. While the client interface 330 of FIG. 3 is directed to residential and/or other similar clients, the client interface 430 may be provided to professional clients. A professional client may be one where the client is an individual, but receives service at a location that is common to other individual clients, such as at a place of business. Accordingly, the client interface 430 may include client information 432 related to an assigned group, an assigned day, an available discount, and an achieved discount. Specifically, some embodiments may be configured to provide discounts to professional clients, based on the number of clients that that group has enrolled. Accordingly, the available discount may be provided. As an example, one discount may include a percentage discount, based on a predetermined number enrollments and/or usages for that group (e.g., a 10% discount if 10 or more clients use the service in a given week). Accordingly, the achieved discount may provide information related to whether the requested discount threshold has been met (e.g., an indication that 10 clients from the group have used the service and thus the 10% discount has been achieved this week). Also included are a download application option 434 and a close option 436.

FIG. 5 depicts a client interface 530 for providing a commercial client with information related to a newly created commercial account, according to embodiments described herein. Similar to the client interface 430 from FIG. 4, FIG. 5 provides client interface 530 for commercial clients after enrollment. Specifically, the client information may include requested service, such as dry cleaning, uniforms, laundry, and/or other services. Specifically, while residential and other individual clients may enroll immediately, there may be a desire to finalize the enrollment of commercial clients in person and/or otherwise to follow-up to complete enrollment. Commercial clients may be able to provide increased volume that may allow for volume discounts. Similar discounts may be provided to other clients that are able to provide increased volume.

FIG. 6 depicts a manager interface 630 for viewing new client enrollment, according to embodiments described herein. In response to receiving an enrollment, the manager computing device 114 may be provided with an information section 632 related to new enrollments. As discussed above, only the manager computing device 114 that manages the area of the new client will receive a notification. However, owner computing devices may receive the manager interface 632 for all managers.

Regardless, the manager interface 630 may be provided to indicate that a new enrollment has been received. As the remote computing device 102 may determine days of service, delivery personnel, times of service, messaging reminders, etc., these may be provided to the manager and/or owner in the manager interface 630. A close option 634 is also included.

It should be understood that, in some embodiments, the manager interface 630 and/or other manager interfaces may be provided via an email or other message. In some embodiments however, the manager interface 630 and/or other manager interface may be provided via a web portal and/or through a manager application that may be accessed by the manager and/or owner with proper authentication. Similarly, the client interfaces, intermediate destination interfaces, and/or delivery personnel interfaces may be provided via messaging, web portals, and/or downloaded applications that have access to the remote computing device 102 with proper authentication for that type of access.

Additionally, some embodiments may be configured to provide the owner, manager, and/or delivery personnel with a reminder to contact the new client to discuss the new service. Specifically, the customer may have questions, and/or need a bag to begin service. Accordingly, these embodiments may indicate to the client when the owner, manager, and/or delivery personnel will contact the client. The owner, manager, and/or delivery personnel will additionally be reminded to contact the client at that time.

FIG. 7 depicts a client interface 730 of a client application 732, which may include an application or other software for providing treatment functionality, accordingly to embodiments described herein. As illustrated, the client computing device 108 may be configured as a mobile computing device with internet access and/or one or more client applications. Accordingly, the client application 732 may be downloaded and accessed via the client interface 730. Similarly, the intermediate destination application, the delivery personnel application, and/or the manager application may be provided via similar interfaces as the client interface 730.

Accordingly, the messages and/or other notifications may be provided to the client (and/or intermediate destination, manager, delivery personnel, etc.) via the client application. Thus, while some messages and/or notifications may be provided via a messaging protocol, those clients with the client application may receive the massages and/or notifications via the client application.

FIG. 8 depicts a client interface 830 for providing a reminder for service, according to embodiments described herein. As discussed above, the remote computing device 102 may send a reminder a predetermined amount of time before a client's service. As such, the reminder may be sent to the client via SMS text message, email, and/or via a notification from a mobile application, such as on the client computing device 108. Also included are a yes laundry option 832, a yes dry cleaning option 834, a yes laundry and dry cleaning option 836, and a no option 838. If the user desires to accept service (e.g., have the items picked up), the client may select one of the yes options 832, 834, 836. In response, a positive notification may be sent to the remote computing device 102 and identify the desired service. If the client selects the no option 838, a negative notification is sent to the remote computing device 102. Regardless of the response from the client, the remote computing device 102 compiles responses from all clients. The remote computing device 102 additionally determines which of the responses are associated with which delivery personnel and populates service forms for the delivery personnel to use when making the upcoming pickups and deliveries.

It should be understood that while the user interface of FIG. 8 is depicted as a mobile application interface, this is merely an example. Specifically, if the notification received is an SMS message, email message, or similar message, the client may respond with a reply message. Accordingly, the remote computing device 102 may recognize text, audio, video, etc. to determine if the client wishes to participate in the upcoming service. This information is then formatted as described above and sent to the delivery personnel computing device 126.

FIG. 9 depicts a client interface 930 for providing a plurality of options for a client to provide options related to the treatment of items, according to embodiments described herein. Specifically, in embodiments with the mobile application, FIG. 9 represents a home screen. Accordingly, the client interface 930 includes a tracking option 932, a schedule option 934, a complaint option 936, an account option 938, and a billing option 940. In response to selection of the tracking option 932, information related to the current location of the client's items may be provided. Specifically, upon receiving the responses to the reminder notification discussed above, the remote computing device 102 may determine which responses belong to which delivery personnel and may populate a list of upcoming pickups. Additionally, the remote computing device 102 may determine which of the clients have items that will be returned on the same day. With this information, the remote computing device 102 may determine a route for making all the pickups and deliveries during the day. Additionally, because the remote computing device 102 may be programmed to know a start time of the day, the remote computing device 102 may additionally determine an approximate time that the delivery personnel will pick up a client's items, deliver the client's items to the intermediate destination, pick the client's items up from the intermediate destination, and deliver back to the client. From this information, the remote computing device 102 can determine a location of the client's items at any given time. Thus, in response to selection of the tracking option 932, this information may be provided to the client.

Similarly, some embodiments may be configured to track the location of the delivery personnel and/or items utilizing other mechanisms. As an example, an RFID tag may be affixed to the items such that when the items are placed in the vehicle 124, the location of the items is recorded. Using navigation tracking, the vehicle 124 may be tracked. Thus, when the items are removed from the vehicle 124, the location may again be recorded. When the items are received or taken from the intermediate destination, the items may be recorded and location sent to the remote computing device 102 for providing to the client. Other tracking mechanisms may also be implemented.

FIG. 10 depicts a client interface 1030 for providing progress of an item that has been picked up, according to embodiments described herein. In response to selection of the tracking option 932 from FIG. 9, the client interface 1030 may be provided. The client interface 1030 may include a list of locations that the client's items have traversed, as well as a contact delivery personnel option 1032 and a map option 1034. By selecting the contact delivery personnel option 1032, a portal for sending a text message or place a phone call may be provided. By selecting the map option 1034, a visual representation of the vehicle 124, the current location of the vehicle 124, and/or each of the previous locations that the vehicle has traveled with the client's items.

FIG. 11 depicts a client interface 1130 for providing emergency pickup options, according to embodiments described herein. In response to selection of the schedule option 934 from FIG. 9, the client interface 1130 may be provided. Specifically, a client may receive the reminder as described above, but may neglect responding to that reminder, even though the client wishes to receive service. In some situations, the client may simply need service on a day that is different than his/her schedule delivery schedule. Accordingly, the client may select a yes option 1132 to schedule the emergency service or a no option 1134 to decline the service. In response to selection of selection of the yes option 1132 the client computing device 108 sends a request to the remote computing device 102 for the emergency service. Based on the current schedules for the available delivery personnel and the current locations of the delivery personnel, the remote computing device 102 may determine whether the request for emergency service may be accommodated. The request may additionally be sent to the manager computing device 114, who may be provided with an option to approve or deny accommodating the request for emergency service. Regardless, if the request is approved, the remote computing device 102 determines which delivery personnel may accommodate the request in the most efficient manner and may alter that delivery personnel's schedule (and thus route) to accommodate that change. Upon approving the request, the client may be sent a notification with instructions, such as a time to make the items available.

It should be understood that while the emergency service may be provided at the client's registered location, this is merely an example. In some embodiments, the remote computing device 102 may determine the client's current location and/or the location of the items and schedule the emergency service to that location. In some embodiments, the client may designate a different location for service in the initial request.

FIG. 12 depicts a client interface 1230 for providing options for submitting a question and/or complaint, according to embodiments described herein. In response to selection of the complaint option 936, the client interface 1230 may be provided. As illustrated, the client interface 1230 includes a question option 1232, a damage option 1234, and a missing option 1236. In response to selection of the question option 1232, an interface for the client to ask a question. The client may input the question, which will be sent to the manager, and/or delivery personnel. Based on the nature of the question, the manager and/or delivery personnel may respond with a textual response or may telephone the client to discuss the question.

In response to selection of the damage option 1234 and/or missing option 1236, the client may be provided with an interface for explaining the damage and/or missing item. Details such as brand of item, nature of damage, service day where item as last seen, age of the item, price of the item, etc. The user may submit images of the item, if available. This information is then sent to the remote computing device 102. The manager computing device 114 and/or the intermediate destination computing device 130 may be provided with this information for resolving the issue.

FIG. 13 depicts a client interface 1330 for providing an automated response to receiving a client question and/or complaint, according to embodiments described herein. In response to inputting the requested data related to the missing and/or damaged item, an automated response may be provided, such as the client interface 1330. An additional details option 1332 is included for providing additional information. A close option 1334 is also included.

FIG. 14 depicts a client interface 1430 for resolving a client question and/or complaint, according to embodiments described herein. Upon receiving the requested information, the manager may determine a solution. The manager may contact the client via a telephone call, and/or other resolution. Upon resolving the issue, the manager may initiate a resolution confirmation, which may be embodied as the client interface 1430. Also included in the client interface 1430 are a details option 1432, a yes option 1434, and a no option 1436. In response to selection of the details option 1432, the client may be provided with details of the issue and resolution to determine whether the issue is resolved. If the issue is resolved, the client may select the yes option 1434, at which point, the issue, resolution, and confirmation of resolution may be stored for subsequent retrieval by the manager or client. If the client selects the no option 1436 is selected, the client may be provided with an interface for further indicating a reason that the issue has not been resolved. As discussed above, this may be again sent to the manager to again attempt to resolve the issue.

FIG. 15 depicts a client interface 1530 for providing details of a resolution of a client question and/or complaint, according to embodiments described herein. In response to selection of the details option 1432 from FIG. 14, the client interface 1530 may be provided. As illustrated, the client interface 1530 may provide a description of the actions that have occurred to create and resolve the issue. The client may select a return option 1532 to return to a previous interface.

FIG. 16 depicts a manager interface 1630 for providing a client question and/or complaint, according to embodiments described herein. In response to selection of the damage option 1234 and/or the missing option 1236 from FIG. 12, the manager interface 1630 may be provided. As illustrated, the manager interface 1630 may indicate that a missing and/or damaged item has been reported and may include a resolved option 1632, a home option 164, a client option 1636, a bills option 1638, and a delivery personnel option 1640. Specifically, upon the client submitting the complaint, the manager interface 1630 may be provided to the manager with details of the issue. The manager may research the issue and determine an appropriate resolution. Upon resolving the matter, the resolved option 1632 may be selected and the manager may indicate the manner in which the issue was resolved. This information may be sent to the remote computing device 102 and/or the client computing device 108, such as via the client interface 1530 from FIG. 15. Additionally, the option s 1634-1640 may be provided for accessing other manager interfaces, as described below.

FIG. 17 depicts a manager interface 1730 for providing a plurality of options related to treatment of items, according to embodiments described herein. Specifically, the manager interface 1730 may be provided up on the manager opening the manager application. Specifically, the manager interface 1730 includes a notifications option 1732, a complaints option 1734, a delivery personnel option 1736, a bills option 1738, a pickups option 1740, and a signups option 1742. As described in more detail below, selection of the notifications option 1732 provides the manager with notifications sent to clients and responses received from clients. Additionally, the manager may be provided with options to identify which clients do not wish to respond to the notifications, which clients do not wish to receive notifications, etc.

Similarly, in response to selection of the complaints option 1734, the manager may view details and resolutions of complaints (missing items, damaged items, and/or other complaints, as described below. In response to selection of the delivery personnel option 1736, the manager may be provided with a list of all delivery personnel under the manager's control, as well as which delivery personnel are currently working, their pickups, deliveries, routes, location, and/or other information. In response to selection of the bills option 1738, data related to revenue and expenses may be provided. Specifically, data such as intermediate destination invoices, fuel charges, employee costs, marketing invoices, client charges and/or other data may be utilized for determining a financial status of the business. Depending on the particular embodiment, the manager may initiate payment of the invoices and/or force charges of the client bills.

In response to selection of the pickups option 1740, the manager may be provided with data related to upcoming pickups of client items. The data may be provided based on responses to notifications and/or based on an upcoming schedule for which notifications have not yet been sent and/or a schedule that is in the process of or is already complete. Depending on the type of data being provided, data related to assigned delivery personnel, times for delivery, and/or other data may also be provided.

In response to selection of the signups option 1742, the manager may be provided with information related to signups for the service. When a new client registers for the service, the client may provide personal information to facilitate registration. This information may be utilized for determining location of service, billing information, whether to receive notifications, etc. Accordingly, this information may be provided to the manager. Additionally, statistics regarding number of signups over a predetermined amount of time, average billing per clients, and/or other information may be provided.

FIG. 18 depicts a manager interface 1830 for viewing delivery personnel information, according to embodiments described herein. In response to selection of the delivery personnel option 1736, the manager interface 1830 may be provided. As illustrated, the manager interface 1830 may provide a listing of delivery personnel under the manager's control. Depending on the number of delivery personnel, the manager interface 1830 may provide an indication of which of the delivery personnel are currently driving, and/or a status of the delivery personnel provided. Additionally, the manager interface 1830 may include delivery personnel options 1832-1838, by which the manager can view details of the selected delivery personnel.

FIG. 19 depicts a manager interface 1930 for providing details of a delivery personnel, according to embodiments described herein. In response to selection of the delivery personnel option 1832 from FIG. 18, the manager interface 190 may be provided. Specifically, the manager interface 1930 provides the selected delivery personnel's current location, as well as a picked up option 1932, a route option 1934, a contact option 1936, and a map 1938. In response to selection of the picked up option 1932, the manager may be provided with information related to items that the delivery personnel has picked up and/or is scheduled to pick up (or deliver). In response to selection of the route option 1934, the manager may be provided with information related to a route that has been determined for the delivery personnel. As discussed above, based on responses to notifications, the remote computing device 102 may determine which delivery personnel are assigned to which deliveries and may determine a route for each delivery personnel. Accordingly, the manager may be provided with that route. In response to selection of the contact option 1936, the manager may initiate a text message, telephone call, video call, and/or other communication with the selected delivery personnel.

FIG. 20 depicts a manager interface 2030 for viewing deliveries that a manager oversees, according to embodiments described herein. In response to selection of the picked up option 1932 from FIG. 19, the manager interface 2030 may be provided. As illustrated, the manager interface 2030 includes a listing of clients that the selected delivery personnel is scheduled to service. Included are the names and pickup location of each scheduled client. Also included are a client pickup section 2034, an intermediate destination drop off section 2036, an intermediate destination pickup section 2038, and a client delivery section 2040. Based on the current status of the delivery personnel, each of these sections may be populated. If the remote computing device 102 determines at least one of those particular portions of the manager interface 2030 may deselect those portions such that it is clear of the delivery personnel's assigned tasks.

As an example, for a particular day, the selected delivery personnel may be assigned to pick up Michael's items, but for Jimmy, Joe, Emily, and Leigh, the delivery personnel needs to pick those items up from the intermediate destination to be delivered to the client. Accordingly, for Michael, the manager interface 2030 will disable the intermediate destination pickup section 2038 and the client delivery section 2040. For the other clients displayed in the manager interface 2030, the client pickup section 2034 and the intermediate destination drop off section 2036 may be disabled because the delivery personnel completed those tasks on a different day. A return option 2032 is also included to return to a previous interface.

It should be understood that while the manager interfaces depicted in FIGS. 16-20 may be directed to a manager, this is merely an example. Depending on the particular embodiment, these interfaces and/or data from these interfaces may be provided to an owner or other entity. If there are multiple locations for the business, the managers may only be provided with information pertinent to their territories, but the owners may be provided with information for all territories.

FIG. 21 depicts a delivery personnel interface 2130 for providing a plurality of options to a delivery personnel, according to embodiments described herein. As illustrated, the delivery personnel interface 2130 may include a pickups option 2132, a route option 2134, a contact manager option 2136, a missing item option 2138, and a drop off option 2140. In response to selection of the pickups option 2132, the delivery personnel may be provided with a listing of pickups that the delivery personnel will make during a given shift. As discussed above, the remote computing device 102 may determine which clients will receive service and will assign those pickups to delivery personnel according to efficiency, time, or other criteria. Based on this determination, the remote computing device 102 may send a listing of pickups to the particular delivery personnel. Similarly, in response to selection of the route option 2134, the route for servicing the clients is provided. As the remote computing device 102 determines the clients that each delivery personnel will service, the remote computing device 102 (and/or delivery personnel computing device 120 may determine a route for reaching providing the desired service.

In response to selection of the contact manager option 2136, the delivery personnel may contact the manager via text message, telephone call, video call, and/or other communication. In response to selection of the missing item option 2138, the delivery personnel may view complaints that clients have provided that the delivery personnel serviced. This may allow the delivery personnel to indicate to the manager the scenario for best addressing the issue. In response to selection of the drop off option 2140, a listing of drop offs that the delivery personnel is scheduled to make may be provided.

FIG. 22 depicts a delivery personnel interface 2230 for providing pickups that a delivery personnel will make over a predetermined time, according to embodiments described herein. In response to selection of the pickups option 212 from FIG. 2, the delivery personnel interface 2230 may be provided. The delivery personnel interface 2230 may include a listing of clients 2232 that the delivery personnel may be scheduled to service. As illustrated, some embodiments may be configured to keep client names anonymous from the delivery personnel perspective. While this is just an example, such a configuration may enable better security to customer lists from delivery personnel and others that may potentially access the delivery personnel computing device 120.

Regardless, the delivery personnel interface 2230 includes a list of clients, as well as pick up from client options 2234 and dropped off at intermediate destination options 2236 for providing a real time record of clients that have been serviced, as well as record location of the client's items. As discussed in more detail below, when a delivery personnel picks up a client's items, the delivery personnel computing device 120 may recognize the location of the delivery personnel. If the delivery personnel's location is the location of the respective client, the delivery personnel computing device 120 may recognize that the delivery personnel is picking up the client's items. Depending on the particular embodiment, the delivery personnel may manually select one of the options 2234 and/or 2236 to indicate that that portion of the delivery personnel's responsibilities have been completed. This information may be reported to the remote computing device 102 for sending to the manager computing device 114 and/or the intermediate destination computing device 130. In some embodiments, the items may include a tracking device, such as a radio frequency identifier (RFID) tag, which may be utilized to indicate that the delivery personnel has picked up the items. Upon making this determination, the delivery personnel computing device 120 may automatically populate the delivery personnel interface 2230 accordingly.

FIG. 23 depicts a delivery personnel interface 2330 for drop-offs that a delivery personnel will make over a predetermined time, according to embodiments described herein. In response to selection of the drop off option 2140 from FIG. 21, the delivery personnel interface 2330 may be provided. As illustrated, the delivery personnel interface 2330 includes a client list 2332, pick up at intermediate destination options 2334, and drop off at client options 2336. As discussed with regard to FIG. 23, the delivery personnel interface 2330 may be utilized for a delivery personnel to record picking up items from an intermediate destination and delivering the treated items back to the client. In some embodiments, a delivery personnel may pick up a client's items and deliver those items to the intermediate destination on a first day. On a second day, the delivery personnel (or another delivery personnel) may pick the treated items up from the intermediate destination and may deliver the treated items back to the client. In some situations, a delivery personnel may pick up client items and, upon delivering those items to the intermediate destination, the delivery personnel will pick up treated items for other clients for delivery that day. As such, the delivery personnel interfaces 2230, 2330 may be combined and/or interchanged depending on the particular embodiment.

FIG. 24 depicts a delivery personnel interface 2430 that provides a route the delivery personnel will take for making the pickups and/or drop-offs, according to embodiments described herein. In response to selection of the route option 2134 from FIG. 21. As illustrated, the delivery personnel interface 2430 includes routing information from the current delivery personnel location to each of the delivery points. Additionally, the estimated time of arrival to each of the destinations along the route. In some embodiments, the delivery personnel computing device 120 may additionally be configured to monitor the time that the delivery personnel is actually taking to traverse the route. As an example, if the delivery personnel is spending too long at a particular location, the delivery personnel computing device 120 may provide a notification to the delivery personnel to begin traveling to the next location.

FIG. 25 depicts a delivery personnel interface 2530 that provides options for verifying that a client has been serviced, according to embodiments described herein. Specifically, when the delivery personnel computing device 120 determines that the delivery personnel has reached one of the designated locations (e.g., a client pickup point), the delivery personnel computing device 120 may provide the delivery personnel interface 2530. As illustrated, the delivery personnel interface 2530 may provide an indication that the delivery personnel has reached the desired location. Also included are an image of the designated location, a laundry pickup option 2534 for the delivery personnel to indicate that the item has been picked up, and a missing option 2538 for the delivery personnel to indicate that the item is not located at the pickup point.

In response to selection of the laundry pickup option 2534 and/or the dry cleaning pickup option 2536, the delivery personnel computing device 120 may populate the delivery personnel interface 2230 (FIG. 22), as well as send an indication to the remote computing device 102 for sending to the manager computing device 114 and/or the intermediate destination computing device 130. In response to selection of the missing option 2538, an indication may be sent to the manager computing device 114 for determining the location of the missing item. Based on the resolution determined by the manager, the manager may update the delivery personnel's route and/or pickups for the day. As an example, the manger may contact the client directly, who may indicate that the item is currently at a different location and may be picked up at that location. Accordingly, the manager may send an indication to the remote computing device 102. The remote computing device 102 may then determine which delivery personnel will be best suited to pick up the client's items at the new location and may reroute the delivery personnel accordingly. As such, the delivery personnel who indicated that the items are missing may receive instructions on how to proceed, which may be received from the remote computing device 102 and/or from the manager.

It should be understood that in some embodiments, the laundry pickup option 2534 and the dry cleaning pickup option 2536 may be provided based on the client selection from FIG. 8. In these embodiments, the options 2534 and 2536 will only be provided if the client requested laundry and dry cleaning services. In some embodiments, the options 2534 and 2536 are provided for all clients and/or for clients who requested laundry and dry cleaning when enrolling.

FIG. 26 depicts an intermediate destination interface 2630 that provides expected deliveries to an intermediate destination, according to embodiments described herein. As discussed above, after a pickup list is determined for each delivery personnel, each delivery personnel will pick up the designated items and record the pickups with the delivery personnel computing device 120. Accordingly, the intermediate destination computing device 130 may receive a list of items that will be delivered by the delivery personnel, as well as an approximate time that the delivery personnel will arrive. If there are numerous delivery personnel delivering to the intermediate destination, this information may also be provided.

As illustrated in the intermediate destination interface 2630, a client list 2632 may be provided, which may include all items that a delivery personnel is delivering. Also included are a delivery personnel list 2634, as well as received options 2638, treated options 2640, and returned options 2642. Specifically, upon receiving the items from the delivery personnel, the intermediate destination may select the respective received option 2638. As discussed above, this may be a manual selection or may be automatically selected based on an electronic determination that the item is currently located in the intermediate destination. Regardless, upon receiving all the items from the delivery personnel, the intermediate destination computing device 130 may perform a check regarding whether all item were received. A return option 2644 is also provided.

Additionally, after the received items are treated, the intermediate destination may select the option that the items were treated. Additionally, some embodiments may provide an option for the intermediate destination to input comments regarding the treatment. As an example, if the items are a plurality of pieces of clothing and the intermediate destination is a dry cleaner, the dry cleaner may indicate that a zipper was also repaired, that an item was received in a damaged condition, that an item could not be cleaned, etc. This information may be provided to the remote computing device 102 such that a manager may decide the appropriate action for informing the client. The manager may contact the client directly, include the comment on the client's invoice, and/or hide the comment from the client.

Similarly, after all the items are treated, an indication may be sent to the remote computing device 102 such to indicate that the items are ready for pickup. While in many embodiments, the delivery personnel have a scheduled pickup schedule from the intermediate destination, there are situations where this indication may assist the delivery personnel if a client requests an item to be delivered early. Additionally, the intermediate destination interface 2630 may additionally include an option for the intermediate destination to indicate that one or more of the items will not be ready before the scheduled pick up time. The intermediate destination may additionally be provided with an option to input comments as to why the items will not be ready as well as an expected time that the item will be ready. This indication and comments may be provided to the remote computing device 102 and/or the manager computing device 114. This will allow the manager to contact the client to indicate the issue and/or the new delivery time. Additionally, the manager may be provided with an interface for manually indicating a one-time change to that client's pickup day, such that the remote computing device 102 may appropriately schedule pickup of the delayed items.

Additionally, some embodiments may be configured to provide the intermediate destination with a standard delay option for the item. Specifically, if the delayed item is a down comforter, it may be known that the standard return time will not apply because a down comforter will need additional drying time. Accordingly, the intermediate destination interface 2630 may include a “down comforter option” to indicate that a down comforter was received and indicate the standard return time. Other similar options may also be provided.

FIG. 27 depicts an intermediate destination interface 2730 that provides options for verifying that deliveries were received by the intermediate destination, according to embodiments described herein. Specifically, the intermediate destination computing device 130 may include and/or be configured to communicate with a point of sale system of the intermediate destination. Regardless, upon receiving and/or treating the received items, an invoice may be generated. The invoice may include a received option 2732, a treated option 2734, and a returned option 2736, which may correspond to the options from FIG. 26. Also included is a detailed listing 2738 of the items received and/or the treatment applied. Additionally, the intermediate destination interface 2730 may provide the total amount charged to that client. This information may be provided to the remote computing device 102 for providing to the manager computing device 114 to facilitate payment of the invoice and/or charging of the client. A return option 2740 may also be provided.

As an example, if the intermediate destination is a third party dry cleaner, the dry cleaner may provide the invoice to the remote computing device 102. The remote computing device 102 may determine the up charge to the client and forward the itemized client invoice to the manager computing device 114 for review. Assuming the invoice is correct, the manager may approve the invoice for sending to the client computing device 108 and automatically bill the client (e.g., such as via a stored credit card, prepayment, etc.). The client may then view the itemized bill via the web portal and/or the client computing device 108. Similarly, if the intermediate destination is not a third party, the itemized treatment invoice may be sent with our without prices, in which case an up charge may not need to be calculated. Regardless, the manager may receive this information for billing the client. As such, in some embodiments and to the extent applicable, the functionality of the manager computing device 114 and the functionality of the intermediate destination computing device 130 may be combined into a single device.

It should be understood that when the intermediate destination completes the accounting of client usage, the billing data may be sent to the remote computing device 102. The remote computing device may calculate price changes (such as markups, discounts, etc.) and may populate the clients' account accordingly. The client may then view their charges via the web portal, client application, etc. Additionally, the remote computing device 102 may facilitate charging the clients at a predetermined time (such as at the end of a billing cycle and/or immediately). The remote computing device 102 may additionally facilitate payment of the intermediate destination for services performed.

FIG. 28 depicts an intermediate destination interface 2830 that provides an indication that one or more items should have been received, according to embodiments described herein. As discussed above, upon completing delivery from the delivery personnel, a determination may be performed regarding whether all the items were received from the delivery personnel. If all the items are not received from the delivery personnel, the intermediate destination interface 2830 may be provided. As illustrated, the intermediate destination interface 2830 includes an indication that an item is missing. This information may be provided to the intermediate destination and/or the delivery personnel for determining the location of the item. Additionally, indication may be sent to the manager for resolving the issue.

Also included are an issue resolved option 2844, a return option 2846, and a resolve issue now option 2848. If the item is located (or the issue is otherwise resolved), the intermediate destination may select the issue resolved option 2844 and/or revise the intermediate destination interface 2630 to account for the located item. If it is determined that the delivery personnel did not pick up the item and thus the item should be removed from the delivered list the delivery personnel and/or manager may be provided with an interface to account for this error. The manager may then determine whether the client will be contacted to schedule a different day for pickup and/or whether the pickup entry may simply be deleted.

If the intermediate destination has not yet resolved the issue, but wishes to do so now, the intermediate destination may select the resolve issue now option 2848. In response, the intermediate destination may be provided with options for providing credits, refunds, etc.

FIG. 29 depicts a flowchart for the treatment of items, according to embodiments described herein. As illustrated in block 2970, a notification may be sent to a plurality of clients, the notification indicating a scheduled pickup of items. In block 2972, a response from at least one of the clients indicating confirmation of the desired service may be received. In block 2974, an interface may be provided to a delivery personnel indicating the at least one client that confirmed the desired service. In block 2976, a route to reach the at least one client and deliver picked up items to an intermediate destination may be provided. In block 2978, a route to reach the intermediate destination and delivered treated items to the at least one client may be provided.

FIG. 30 depicts a remote computing device 102 that may be utilized for the treatment of items, according to embodiments described herein. In the illustrated embodiment, the remote computing device 102 includes a processor 3030, input/output hardware 3032, network interface hardware 3034, a data storage component 3036 (which stores video data 3038a and state data 3038b), and the memory component 140. The memory component 140 includes hardware and may be configured as volatile and/or nonvolatile memory and, as such, may include random access memory (including SRAM, DRAM, and/or other types of RAM), flash memory, registers, compact discs (CD), digital versatile discs (DVD), and/or other types of non-transitory computer-readable mediums. Depending on the particular embodiment, the non-transitory computer-readable medium may reside within the remote computing device 102 and/or external to the remote computing device 102.

Additionally, the memory component 140 may be configured to store operating logic 3042, the wagering logic 144a, and the calculating logic 144b, each of which may be embodied as a computer program, firmware, and/or hardware, as an example. A local communications interface 3046 is also included in FIG. 30 and may be implemented as a bus or other interface to facilitate communication among the components of the remote computing device 102.

The processor 3030 may include any hardware processing component operable to receive and execute instructions (such as from the data storage component 3036 and/or memory component 140). The input/output hardware 3032 may include and/or be configured to interface with a monitor, keyboard, mouse, printer, camera, microphone, speaker, and/or other device for receiving, sending, and/or presenting data. The network interface hardware 3034 may include and/or be configured for communicating with any wired or wireless networking hardware, a satellite, an antenna, a modem, LAN port, wireless fidelity (Wi-Fi) card, WiMax card, mobile communications hardware, and/or other hardware for communicating with other networks and/or devices. From this connection, communication may be facilitated between the remote computing device 102 and other computing devices.

Similarly, it should be understood that the data storage component 3036 may reside local to and/or remote from the remote computing device 102 and may be configured to store one or more pieces of data for access by the remote computing device 102 and/or other components. In some embodiments, the data storage component 3036 may be located remotely from the remote computing device 102 and thus accessible via the network 100. In some embodiments however, the data storage component 3036 may merely be a peripheral device, but external to the remote computing device 102.

Included in the memory component 140 are the operating logic 3042, the message providing logic 106a, the enrollment logic 106b, the data providing logic 106c, and the billing logic 106d. The operating logic 3042 may include an operating system and/or other software for managing components of the remote computing device 102. Similarly, the message providing logic 106a may be configured to provide notifications to the clients, as described above. The enrollment logic 106b may facilitate enrollment of new clients. The data providing logic 106c may be configured to provide information to owners, delivery personnel, and/or clients. The billing logic 106d may be configured to provide billing capabilities to the owners and/or managers, as well as provide billing data to clients.

It should be understood that the components illustrated in FIG. 30 are merely exemplary and are not intended to limit the scope of this disclosure. While the components in FIG. 60 are illustrated as residing within the remote computing device 102, this is merely an example. In some embodiments, one or more of the components may reside external to the remote computing device 102.

It should also be understood that while FIG. 30 depicts the remote computing device 102, this is merely an example. Any of the devices depicted in FIG. 1 may include similar hardware and/or software for providing the desired functionality described herein.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

Therefore, at least the following is claimed:

1. A method for facilitating delivery of an item, comprising:
sending notification to a plurality of clients, the notification indicating a scheduled pickup of items;
receiving a response from at least one of the clients indicating confirmation of the scheduled pickup;
providing an interface to a delivery personnel indicating the at least one clients that confirmed the scheduled pickup of items; and
providing a first route to reach the at least one client and deliver picked up items to an intermediate destination.

2. The method of claim 1, further comprising:
receiving a notification from at least one of the clients indicating an emergency service; and
changing the first route to accommodate the emergency service.

3. The method of claim 1, further comprising:
tracking a location of the items; and
providing the location of the items to a respective client.

4. The method of claim 1, further comprising:
receiving, from a user computing device an indication that at least one of the picked up items has an issue; and
forwarding information related to the issue to a manager;
providing a user interface for the manger to indicate that the issue has been resolved; and
providing an indication to the user that the issue has been resolved

5. The method of claim 1, further comprising providing a user interface to a manager for locating the delivery personnel, wherein the user interface includes at least one of the following: the first route the delivery personnel is taking, a current location of the delivery personnel, an option to contact the delivery personnel, and a listing of items that the delivery personnel has treated.

6. The method of claim 1, wherein the delivery personnel is provided with an interface to confirm progress on the first route.

7. The method of claim 1, further comprising populating a second route, based on completion of the first route.

8. A system for facilitating delivery of an item, comprising:
a memory component that stores logic that, when executed by a processor, causes the system to perform at least the following:
send notification to a plurality of clients, the notification indicating a scheduled pickup of items;
provide an interface to a delivery personnel indicating the at least one clients that confirmed the desired service; and
provide a first route to reach the at least one client and deliver picked up items to an intermediate destination.

9. The system of claim 8, wherein the logic further causes the system to perform the following:
receive a notification from at least one of the clients indicating an emergency desired service; and
change the first route to accommodate the emergency desired service.

10. The system of claim 8, wherein the logic further causes the system to perform the following:
track a location of the items; and
provide the location of the items to a respective client.

11. The system of claim 8, wherein the logic further causes the system to perform the following:
receive, from a user computing device an indication that at least one of the treated items has an issue; and
forward information related to the issue to a manager;
provide a user interface for the manger to indicate that the issue has been resolved; and
provide an indication to the user that the issue has been resolved

12. The system of claim 8, wherein the logic further causes the system to provide a user interface to a manager for locating the delivery personnel, wherein the user interface includes at least one of the following: the first route the delivery personnel is taking, a current location of the delivery personnel, an option to contact the delivery personnel, and a listing of items that the delivery personnel has treated.

13. The system of claim 8, wherein the delivery personnel is provided with an interface to confirm progress on the first route.

14. The system of claim 8, wherein the logic further causes the system to populate a second route, based on completion of the first route.

15. A computing device for facilitating delivery of an item, comprising:
a processor; and
a memory component that is coupled to the processor and stores logic that, when executed by the processor, causes the computing device to perform at least the following:
send notification to a plurality of clients, the notification indicating a scheduled pickup of items;
provide an interface to a delivery personnel indicating the at least one clients that confirmed the desired service; and
provide a first route to reach the at least one client and deliver picked up items to an intermediate destination.

16. The computing device of claim 15, wherein the logic further causes the computing device to perform the following:
receive a notification from at least one of the clients indicating an emergency desired service; and
change the first route to accommodate the emergency desired service.

17. The computing device of claim 15, wherein the logic further causes the computing device to perform the following:
track a location of the items; and
provide the location of the items to a respective client.

18. The computing device of claim 15, wherein the logic further causes the computing device to perform the following:
receive, from a user computing device an indication that at least one of the treated items has an issue; and
forward information related to the issue to a manager;
provide a user interface for the manger to indicate that the issue has been resolved; and
provide an indication to the user that the issue has been resolved

19. The computing device of claim 15, wherein the logic further causes the computing device to provide a user interface to a manager for locating the delivery personnel, wherein the user interface includes at least one of the following: the first route the delivery personnel is taking, a current location of the delivery personnel, an option to contact the delivery personnel, and a listing of items that the delivery personnel has treated.

20. The computing device of claim 15, wherein the logic further causes the computing device to populate a second route, based on completion of the first route.
